(19) United States
(12) Patent Application Publication
(10) Pub. No.: US 2022/0385496 A1
(43) Pub. Date: Dec. 1, 2022

(54) CONTROL SYSTEM AND CONTROL METHOD

(71) Applicant: Panasonic Intellectual Property Management Co., Ltd., Osaka (JP)

(72) Inventors: Kousei MATSUNAMI, Kyoto (JP); Kiyonori KIDO, Tokyo (JP); Yoshihiro KOGA, Osaka (JP); Makoto HIROKI, Tokyo (JP)

(21) Appl. No.: 17/765,194

(22) PCT Filed: Aug. 14, 2020
(86) PCT No.: PCT/JP2020/030918

§ 371 Date: Mar. 30, 2022

(30) Foreign Application Priority Data
Sep. 30, 2019 (JP) 2019-180054

(51) Int. Cl. H04L 12/28

(52) U.S. Cl. CPC H04L 12/2827; H04L 12/2812; H04L 12/282; H04L 2012/285

(57) ABSTRACT

A control system includes: an input receiver that receives an execution instruction to execute scene control that is associated with a life scene and includes control of a first device and control of a second device; and a controller that executes the control of the first device and the control of the second device at different timings when the execution instruction is received.

### CROSS-REFERENCE OF RELATED APPLICATIONS

This application is the U.S. National Phase under 35 U.S.C. § 371 of International Patent Application No. PCT/JP2020/030918, filed on Aug. 14, 2020, which in turn claims the benefit of Japanese Application No. 2019-180054, filed on Sep. 30, 2019, the entire disclosures of which Applications are incorporated by reference herein.

The present invention relates to a control system and a control method.

### BACKGROUND ART

In recent years, a home energy management system (HEMS) has been introduced to houses. HEMS implements “visualization” in which the amount of usage of energy such as electricity and gas for house use is displayed on a monitor. Moreover, HEMS can be also used as a control system for controlling household electrical appliances installed in a house. PTL 1 discloses a remote control technique for information appliances using HEMS.

### CITATION LIST

### Patent Literature

[PTL 1] Japanese Unexamined Patent Application Publication No. 2014-203411

### SUMMARY OF INVENTION

### Technical Problem

The present invention relates to a control system and a control method that can implement flexible device control.

### Solution to Problem

In accordance with an aspect of the present invention, a control system includes: an input receiver that receives an execution instruction to execute scene control associated with a life scene, the scene control including first control of controlling a first device and second control of controlling a second device; and a controller that executes the first control and the second control at different timings when the execution instruction is received.

In accordance with another aspect of the present invention, a control method executed by a computer includes: receiving an execution instruction to execute scene control associated with a life scene, the scene control including first control of controlling a first device and second control of controlling a second device; and executing the first control and the second control at different timings when the execution instruction is received in the receiving.

In accordance with still another aspect of the present invention, a non-transitory computer-readable recording medium for use in a computer, the recording medium having a computer program recorded thereon for causing the computer to execute the above-described control method.

### Advantageous Effect of Invention

The control system and the control method of the present invention can implement flexible device control.

### BRIEF DESCRIPTION OF DRAWINGS

FIG. 1 is a block diagram illustrating a functional configuration of a control system according to an embodiment.

FIG. 2 is a diagram illustrating an example of control information for executing scene control.

FIG. 3 is a flowchart showing operation example 1 of the control system according to the embodiment.

FIG. 4 is a diagram illustrating an example of a setting screen of control timings.

FIG. 5 is a flowchart showing operation example 2 of the control system according to the embodiment.

FIG. 6 is a diagram illustrating an example of a setting screen of control timings in operation example 2.

FIG. 7 is a flowchart showing operation example 3 of the control system according to the embodiment.

FIG. 8 is a diagram illustrating an example of a setting screen of control timings in operation example 3.

FIG. 9 is a flowchart showing operation example 4 of the control system according to the embodiment.

FIG. 10 is a diagram illustrating an example of a setting screen of control timings in operation example 4.

FIG. 11 is a flowchart showing operation example 5 of the control system according to the embodiment.

FIG. 12 is a diagram illustrating an example of a setting screen of control timings in operation example 5.

FIG. 13 is a flowchart showing operation example 6 of the control system according to the embodiment.

FIG. 14 is a diagram illustrating an example of a setting screen of control timings in operation example 6.

FIG. 15 is a diagram illustrating an example of an input screen of “going-out” time.

### DESCRIPTION OF EMBODIMENTS

Hereinafter, certain exemplary embodiments will be described in detail with reference to the accompanying Drawings. The following embodiments are general or specific examples of the present invention. The numerical values, shapes, materials, elements, arrangement and connection configuration of the elements, steps, the order of the steps, etc., described in the following embodiments are merely examples, and are not intended to limit the present invention. Among elements in the following embodiments, those not described in any one of the independent claims indicating the broadest concept of the present invention are described as optional elements.

It should be noted that the respective figures are schematic diagrams and are not necessarily precise illustrations. Additionally, components that are essentially the same share like reference signs in the figures. Accordingly, overlapping explanations thereof are omitted or simplified.

Moreover, terms such as “immediately after” and “instantly” that indicate timings in the following embodiment are not to be interpreted as strict meanings.

### Embodiment

### [Configuration]

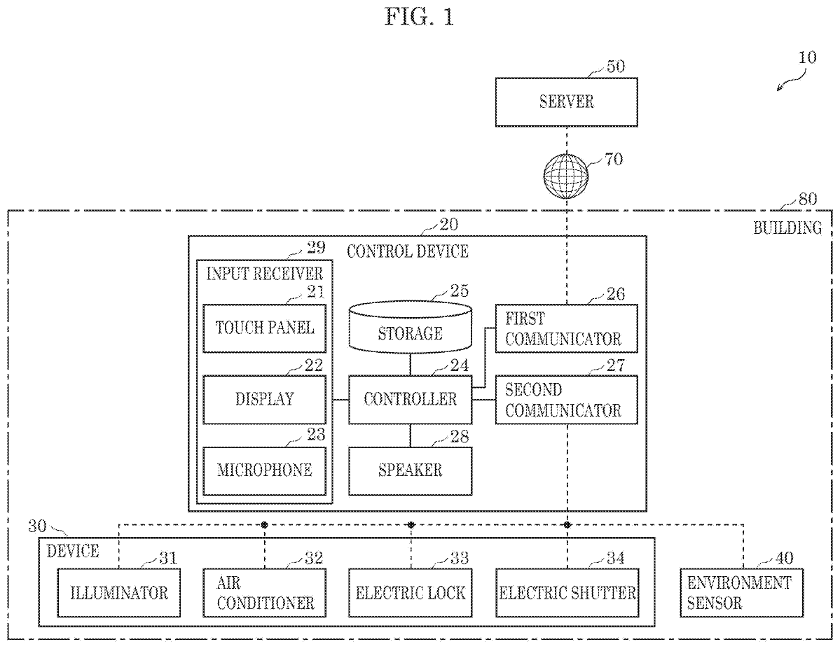

The configuration of a control system according to an embodiment will be first described below. FIG. 1 is a block diagram illustrating a functional configuration of the control system according to the embodiment.

As illustrated in FIG. 1, control system 10 includes control device 20, device 30, environment sensor 40, and server 50.

Building 80 illustrated in FIG. 1 is a house, for example, an apartment house or a detached house. Control device 20 and device 30 are installed in building 80. Server 50 is implemented as a cloud (i.e., a cloud server).

Control device 20 will be first described below. Control device 20 is, for example, an HEMS controller having an energy management function. Control device 20 is installed in building 80 to manage the power consumption of device 30 installed in building 80. Moreover, control device 20 acquires and displays a state of device 30 and controls device 30 installed in building 80 (or in the site of building 80). Control device 20 is not limited to an HEMS controller. Other home controllers having no energy management function or a gateway device may be used instead.

Device 30 is a household electrical appliance such as illuminator 31 and air conditioner 32. A state of device 30 means, for example, an operation state of device 30 and a state of power consumption of device 30. Specifically, an operation state includes a power-on state, a power-off state, and a setting state (a set temperature when an air conditioner serves as device 30 or brightness when an illuminator serves as device 30).

Specifically, control device 20 includes touch panel 21, display 22, microphone 23, controller 24, storage 25, first communicator 26, second communicator 27, and speaker 28. Touch panel 21, display 22, and microphone 23 constitute input receiver 29.

Touch panel 21 receives the operation input of a user. Touch panel 21 is, for example, a capacitive touch panel and may be a resistive touch panel.

Display 22 displays an image based on the control of controller 24. Display 22 is, for example, a display panel such as a liquid crystal panel or an organic electro luminescence (EL) panel.

Microphone 23 receives the voice input of the user. Microphone 23 is an example of a voice acquirer.

Controller 24 executes, for example, display control of an image on display 22 and voice recognition of a voice input to microphone 23. Controller 24 is implemented by, for example, a microcomputer. Controller 24 may be implemented by a processor.

Storage 25 is a storage device for storing, for example, control programs executed by controller 24. Storage 25 is implemented by, for example, semiconductor memory or the like.

First communicator 26 is a communication module (communication circuit) for communications between control device 20 and server 50 via wide area network 70, e.g., the Internet. Communications conducted by first communicator 26 is, for example, radio communications. Cable communications may be conducted instead. Communications standards used for such communications are not particularly limited.

Second communicator 27 is a communication module (communication circuit) for communications between control device and device 30 via a local communication network. Communications conducted by second communicator 27 is, for example, radio communications. Cable communications may be conducted instead. Communications standards used for such communications are not particularly limited. Communications between second communicator 27 and device 30 are compliant with, for example, ECHONET Lite (registered trademark).

Speaker 28 outputs a voice based on the control of controller 24. Speaker 28 is an example of a voice outputter.

Device 30 and environment sensor 40 will be described below. Device 30 is a device to be controlled by control device 20. Device 30 includes, for example, a communication module (communication circuit) for communications with control device 20 and operates according to a control signal received from control device 20. Device 30 includes, for example, illuminator 31, air conditioner 32, electric lock 33, and electric shutter 34.

Device 30 may include other devices. For example, device 30 may include devices such as a distribution switch board or a smart meter that measures power consumption in building 80. Power consumption measured by such devices is stored in storage 25 as history information about power consumption.

Illuminator 31 illuminates the inside (interior) of building 80. Illuminator 31 is, for example, a ceiling light. A specific form of illuminator 31 is not particularly limited. Illuminator 31 may be, for example, a downlight, a pendant light, a spot light, or a bracket light. Alternatively, illuminator 31 may be an illuminator for illuminating the outside (exterior) of building 80.

Air conditioner 32 is an air conditioner for ordinary households. Air conditioner 32 is an air conditioner including a heat exchanger (not illustrated), thereby adjusting the temperature of wind blowing from air conditioner 32. In other words, air conditioner 32 has a temperature adjusting function (air-blowing function and air conditioning function). Air conditioner 32 is not limited to an air-conditioner for ordinary households. An industrial air conditioner may be used instead.

Electric lock 33 is a security device for controlling the locking and unlocking of a door (or a window) provided for building 80. Electric lock 33 includes, for example, an RFID reader for acquiring key information from a card key or the like. Alternatively, electric lock 33 may be provided with a biological sensor for acquiring, as key information, biological information including fingerprints. In the following embodiment, electric lock 33 will be described as an electric lock provided on an entrance door.

Electric shutter 34 is disposed outside (or inside) a window of building 80 and adjusts the amount of natural light brought into building 80. Electric shutter 34 is, for example, an electric blind that is configured to physically open and close a shield against light. Electric shutter 34 may include a liquid crystal panel and may be configured to change light transmittance as physical properties.

Environment sensor 40 senses environments inside or outside building 80. Environment sensor 40 is, for example, an illuminance sensor, a temperature sensor, a humidity sensor, or a fine-particle concentration sensor.

### [Scene Control]

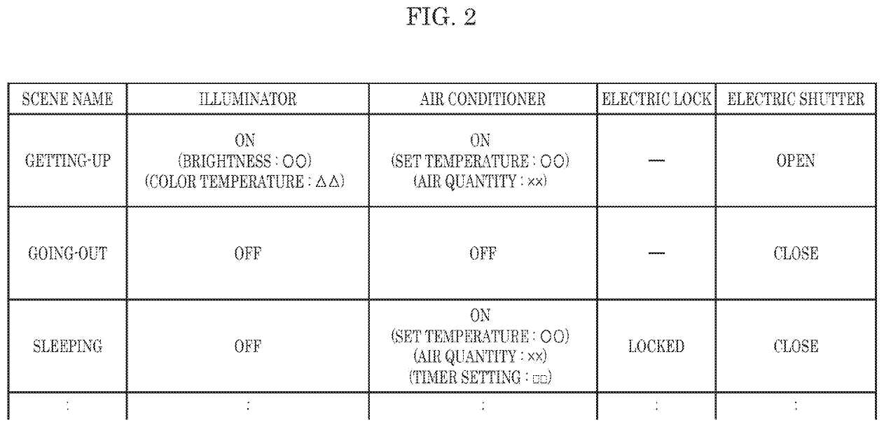

Scene control executed by control device 20 will be described below. In scene control, two or more devices 30 disposed in building 80 are collectively operated to bring the inside of building 80 to a predetermined indoor environment. FIG. 2 is a diagram illustrating an example of control information for executing scene control.

In the control information on scene control, the control contents of device 30 are associated with respective life scenes (scene names) including getting-up, going-out, and sleeping. For example, when a user operates touch panel 21 to provide an execution instruction to execute scene control of “getting-up,” control device 20 controls device 30 with reference to the control information of FIG. 2. Thus, illuminator 31 and air conditioner 32 are turned on with preregistered settings (including brightness and a set temperature), thereby opening electric shutter 34. The user can preregister an operation to be executed by device 30 and which one of devices 30 is to execute the operation when the execution instruction to execute scene control of “getting-up” is provided.

Such scene control allows the user to operate two or more devices with one action (e.g., one touch).

### OPERATION EXAMPLE 1

Typically, when an execution instruction to execute the scene control is provided, control device 20 starts simultaneously controlling two or more devices to be controlled. Unlike control device 20, control system 10 can start controlling two or more devices at different timings. In this case, “different timings” means substantially different timings (significant differences in timing). In other words, “different timings” means a large difference that exceeds a small difference in control timing, the small difference being caused by, for example, a delay in communications and the response speed of device 30.

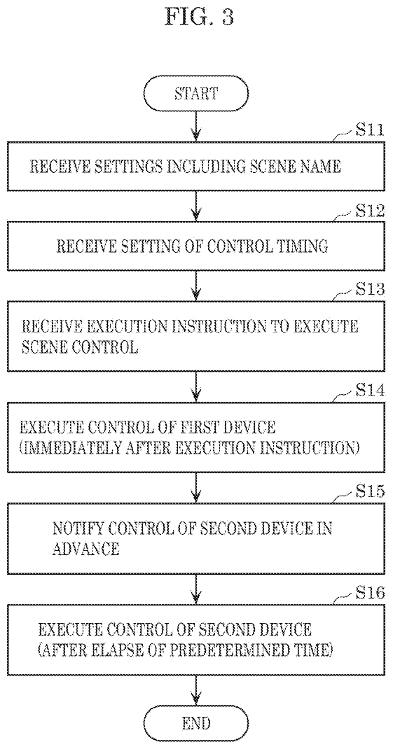

Operation example 1 of control system 10 configured thus will be described below. FIG. 3 is a flowchart showing operation example 1 of control system 10.

In the following description of operation example 1, a device to be controlled is also referred to as a first device when control for the device is started immediately after an execution instruction to execute scene control is provided, whereas a device to be controlled is also referred to as a second device when control for the device is started after a predetermined time period elapses since an execution instruction to execute scene control is provided.

Touch panel 21 of control device 20 first receives settings including a scene name, a device to be controlled, and the contents of control from the user (S11). The receiving of the settings generates the control information (FIG. 2) stored in storage 25. As shown in FIG. 2, for example, in control information about scene control of “going-out,” a scene name “going-out” is associated with control for turning off illuminator 31 and air conditioner 32, control for locking electric lock 33, and control for closing electric shutter 34.

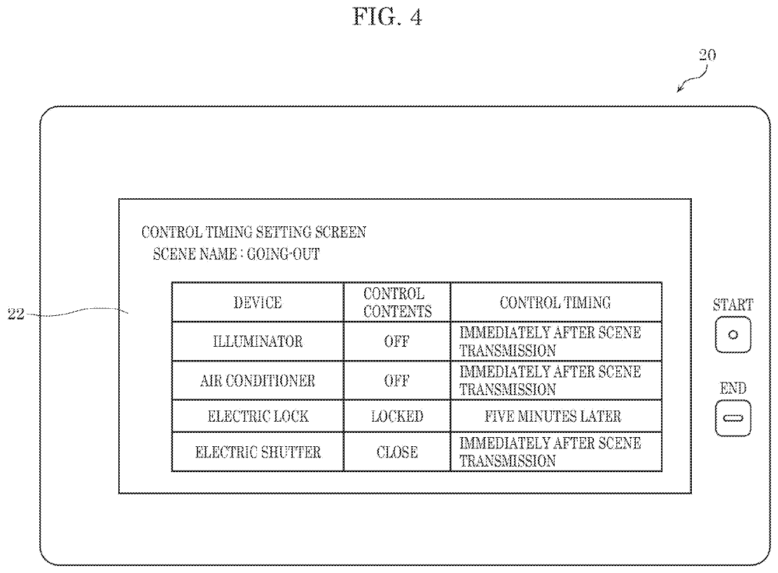

Touch panel 21 of control device 20 then receives the setting of a control timing of scene control (S12). At this point, controller 24 displays a setting screen on display 22 as illustrated in FIG. 4. FIG. 4 is a diagram illustrating an example of the setting screen of control timings. As indicated in FIG. 4, the user can set a control timing (in other words, a control execution timing, a control start timing, or a delay time) for each of two or more devices to be controlled. The set control timing is stored as, for example, part of control information in storage 25.

For example, the scene control of “going-out” is used immediately before the user goes out. Thus, in the scene control of “going-out,” electric lock 33 provided on an entrance door is preferably locked after the user exits building 80 rather than immediately after the user operates control device 20 (touch panel 21) in building 80 to provides an execution instruction to execute the scene control of “going-out.” For this reason, for example, the user sets the control timing of electric lock 33 with a delay of a predetermined time period from other devices 30. The predetermined time period is a time exceeding 0, e.g., a time of one minute to ten minutes (five minutes in the example of FIG. 4). The predetermined time period may be optionally set by the user and is not particularly limited.

Touch panel 21 then receives, from the user, the execution instruction to execute scene control (S13). Based on the control timing (in other words, control information stored in storage 25) set in step S12, controller 24 executes control of the first device immediately after the receiving of the execution instruction (S14). For example, when the execution instruction to execute the scene control of “going-out” is received in step S13, controller 24 causes second communicator 27 to transmit a control signal to each of illuminator 31, air conditioner 32, and electric shutter 34. Thus, illuminator 31 and air conditioner 32 are turned off, and electric shutter 34 is closed.

Moreover, controller 24 notifies the start of control of the second device different from the first device, shortly before a predetermined time period (e.g., one minute) elapses after the receiving of the execution instruction (S15). For example, when the execution instruction to execute the scene control of “going-out” is received in step S13, controller 24 causes speaker 28 to output a voice (message) “The electric lock will be immediately locked,” which completes the notification. Controller 24 may provide a notification by displaying an image on display 22. Alternatively, such a notification may be omitted.

Based on the control timing (in other words, control information stored in storage 25) set in step S12, controller 24 executes control of the second device when a predetermined time period elapses after the receiving of the execution instruction (S16). For example, when the execution instruction to execute the scene control of “going-out” is received in step S13, controller 24 causes second communicator 27 to transmit a control signal to electric lock 33 five minutes after the receiving of the execution instruction. Thus, electric lock 33 is locked. When the second device is absent as a result of the setting of the control timing in step S12, step S15 and step S16 are omitted.

As described above, in operation example 1, control system 10 executes the control of the first device and the control of the second device at different timings in the receiving of the execution instruction to execute scene control associated with a life scene. Specifically, control system 10 executes the control of the first device immediately after the receiving of the execution instruction to execute scene control, and executes the control of the second device when a predetermined time period elapses after the receiving of the execution instruction to execute scene control. In operation example 1, the setting of at least one of a timing for executing the control of the first device and a timing for executing the control of the second device is received before the receiving of the execution instruction to execute scene control.

Control system 10 configured thus can implement flexible device control and improve convenience for users with flexible device control.

### OPERATION EXAMPLE 2

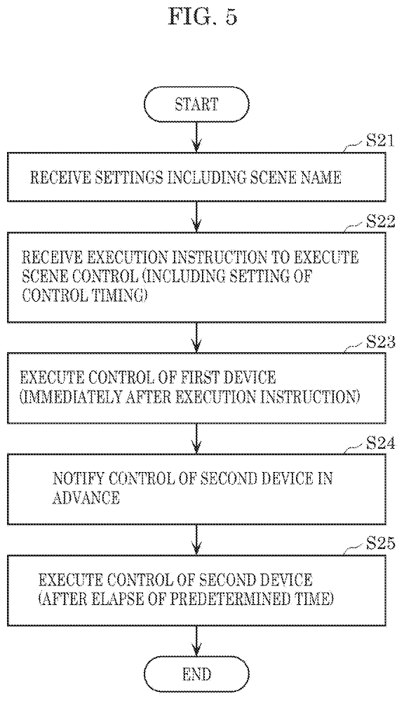

In operation example 1, the control timing is set before the receiving of the execution instruction to execute scene control. The execution instruction to execute scene control may include the setting of the control timing. FIG. 5 is a flowchart showing operation example 2 of control system 10. In the following description of operation example 2, differences from operation example 1 will be mainly discussed, and an explanation of matters mentioned above is optionally omitted or simplified.

Touch panel 21 of control device 20 first receives settings including a scene name, a device to be controlled, and the contents of control from the user (S21). Touch panel 21 then receives, from the user, the execution instruction to execute scene control, the execution instruction including the instruction of a control timing (S22).

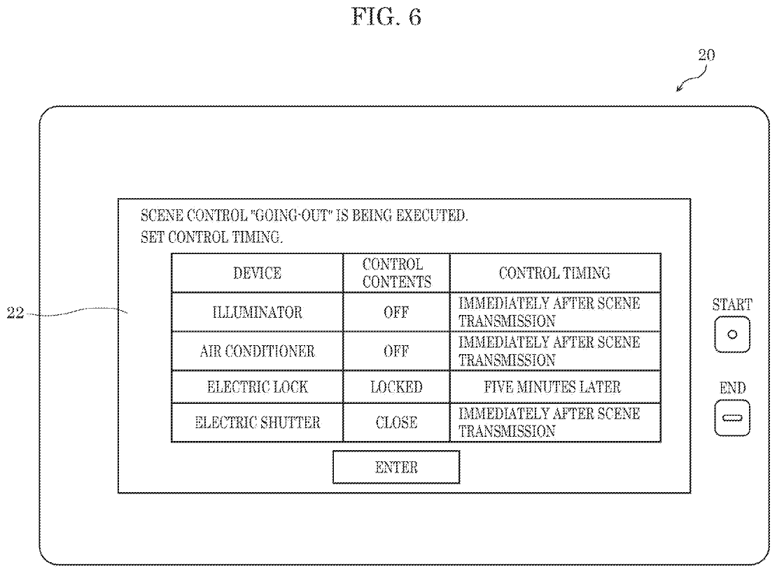

In operation example 2, the execution instruction to execute scene control is divided into two phases: (1) the selection of scene control and (2) the setting of the control timing of a device to be controlled by the selected scene control. For example, after the selection of scene control by the user is received through touch panel 21, controller 24 displays the setting screen of a control timing on display 22 before executing the selected scene control. FIG. 6 is a diagram illustrating an example of the setting screen of control timings in operation example 2.

As illustrated in FIG. 6, in operation example 2, a user operation for an execution instruction to execute scene control includes a setting operation of a control timing. The execution instruction to execute scene control is completed by operating “Enter” button on the screen of FIG. 6.

At the completion of the execution instruction to execute scene control, based on the control timing set in step S22, controller 24 executes the control of the first device immediately after the completion of the execution instruction (S23). For example, when the execution instruction to execute the scene control of “going-out” is received in step S22, controller 24 causes second communicator 27 to transmit a control signal to each of illuminator 31, air conditioner 32, and electric shutter 34.

Based on the control timing set in step S22, controller 24 notifies the start of the control of the second device (S24) and then executes the control of the second device when a predetermined time period elapses after the receiving of the execution instruction (S25).

When the second device is absent as a result of the setting of the control timing in step S22, step S24 and step S25 are omitted.

As described above, in operation example 2, control system 10 receives the setting of at least one of the timing for executing the control of the first device and the timing for executing the control of the second device when receiving the execution instruction to execute scene control. According to operation example 2, the user can provide an instruction about a control timing immediately before the execution of scene control. In other words, the user can provide an instruction about a control timing in consideration of the current circumstances.

### OPERATION EXAMPLE 3

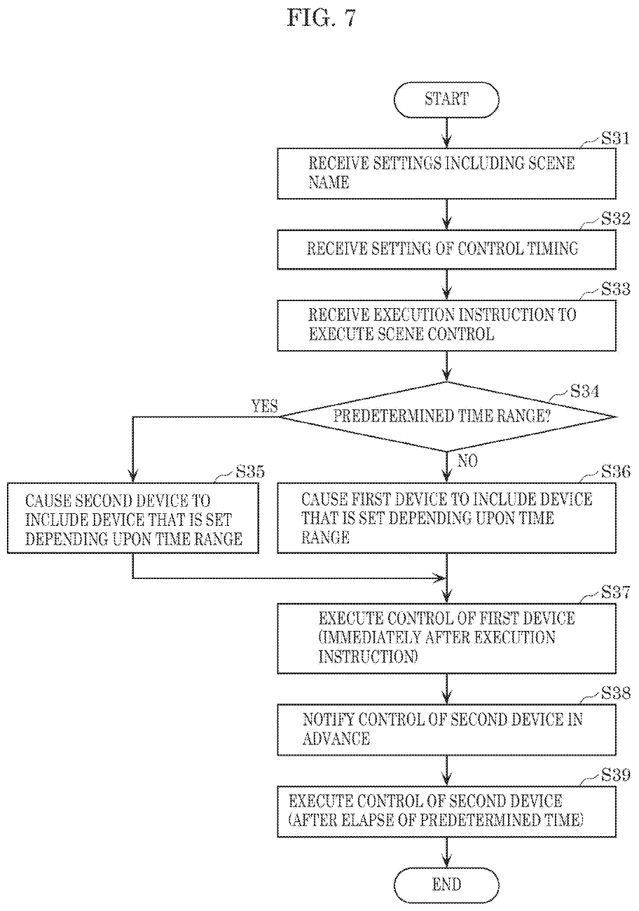

The setting of the control timing in operation example 1 may include the setting of different control timings according to a time range (time period of a day) in which the execution instruction is provided. FIG. 7 is a flowchart showing operation example 3 of control system 10. In the following description of operation example 3, differences from operation example 1 will be mainly discussed, and an explanation of matters mentioned above is optionally omitted or simplified.

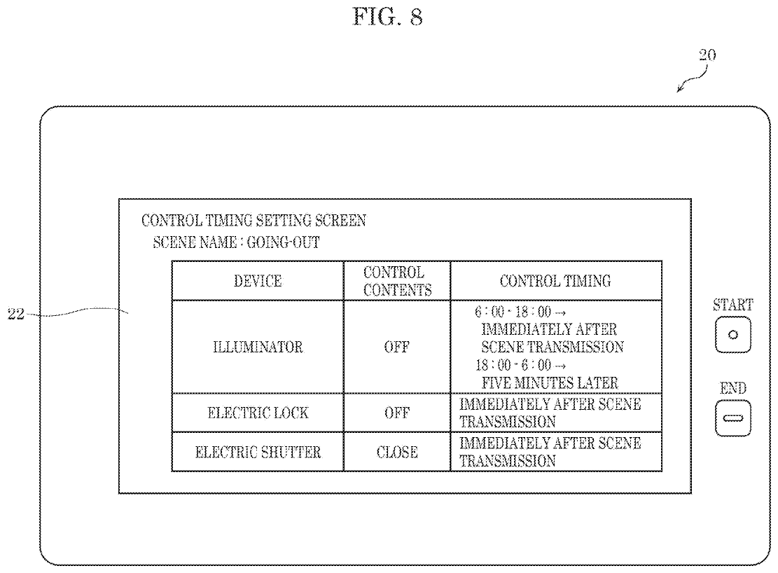

Touch panel 21 of control device 20 first receives settings including a scene name, a device to be controlled, and the contents of control from the user (S31). Touch panel 21 of control device 20 then receives the setting of a control timing of scene control (S32). At this point, controller 24 displays a setting screen on display 22 as illustrated in FIG. 8. FIG. 8 is a diagram illustrating an example of the setting screen of control timings in operation example 3.

As illustrated in FIG. 8, operation example 3 controls three devices: illuminator 31, electric lock 33, and electric shutter 34. In the setting screen, the control timing of illuminator 31 depends upon a time range. Illuminator 31 is set to be turned off immediately after the execution instruction is provided in the time range of 6:00 to 18:00, during which it is bright outside the building. Moreover, illuminator 31 is set to be turned off when a predetermined time period elapses after the execution instruction is provided in the time range of 18:00 to 6:00 (hereinafter also referred to as a predetermined time range), during which it is dark outside the building. The set control timing is stored as, for example, part of control information in storage 25. The predetermine time range and the length of the predetermined time can be optionally set by the user.

Touch panel 21 then receives, from the user, the execution instruction to execute scene control (S33). Controller 24 determines whether a time range in which the execution instruction is received belongs to a predetermined time range of 18:00 to 6:00, by measuring the current time (S34). When it is determined that the time range in which the execution instruction is received belongs to the predetermined time range (Yes at S34), controller 24 causes the second device to include illuminator 31 that is set depending upon the time range (S35). When it is determined that the time range in which the execution instruction is received does not belong to the predetermined time range (No at S34), controller 24 causes the first device to include illuminator 31 that is set depending upon the time range (S36).

Based on the control timing set in step S32, controller 24 executes the control of the first device immediately after the receiving of the execution instruction (S37). Based on the control timing set in step S32, controller 24 notifies the start of the control of the second device (S38) and then executes the control of the second device when a predetermined time period elapses after the receiving of the execution instruction (S39). When the second device is absent, step S38 and step S39 are omitted.

Hence, illuminator 31 is turned off immediately after the user instructs execution of the scene control of “going-out” when it is bright outside building 80, whereas illuminator 31 is turned off later after the user instructs execution of the scene control of “going-out” when it is dark outside building 80.

As described above, when the execution instruction is received in operation example 3, control system 10 executes the control of the first device and the control of the second device at different timings based on the time range in which the execution instruction is received.

According to operation example 3, control system 10 can adaptively change the control timing of illuminator 31 according to the time range in which the execution instruction to execute scene control is provided.

### OPERATION EXAMPLE 4

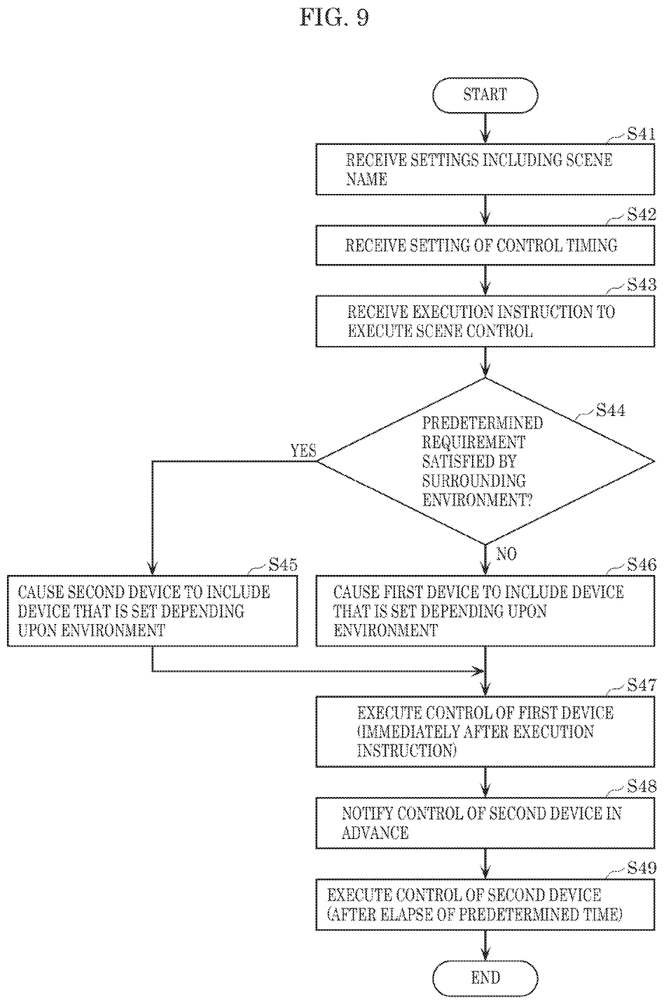

The setting of the control timing in operation example 1 may include the setting of different control timings according to the surrounding environment of building 80 when an execution instruction is provided. FIG. 9 is a flowchart showing operation example 4 of control system 10. In the following description of operation example 4, differences from operation example 1 will be mainly discussed, and an explanation of matters mentioned above is optionally omitted or simplified.

Touch panel 21 of control device 20 first receives settings including a scene name, a device to be controlled, and the contents of control from the user (S41). Touch panel 21 of control device 20 then receives the setting of a control timing of scene control (S42).

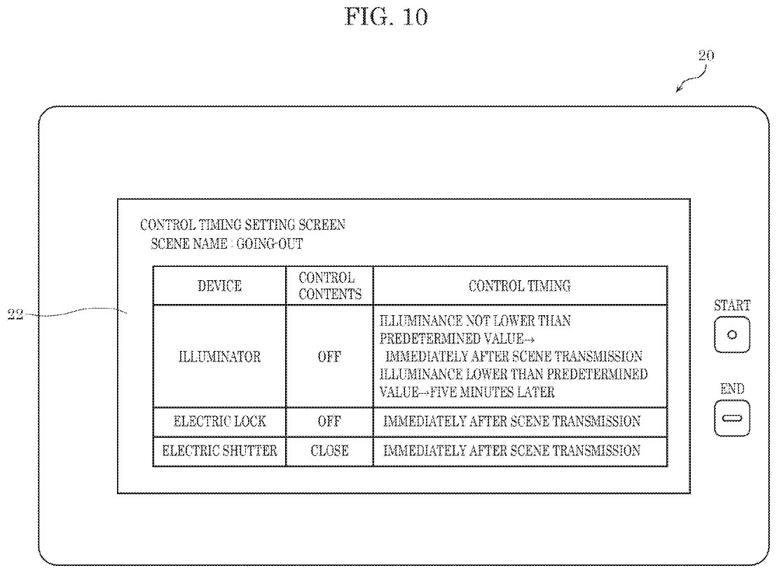

At this point, controller 24 displays a setting screen on display 22 as illustrated in FIG. 10. FIG. 10 is a diagram illustrating an example of the setting screen of control timings in operation example 4.

As illustrated in FIG. 10, operation example 4 controls three devices: illuminator 31, electric lock 33, and electric shutter 34. In the setting screen, the control timing of illuminator 31 depends upon a sensing result (environment) of environment sensor 40 (in this case, an illuminance sensor). In other words, the control timing of illuminator 31 depends upon the surrounding environment of building 80. When an illuminance around building 80 (outdoor) is equal to or higher than a predetermined value (in other words, it is bright outside building 80) at a timing for providing an execution instruction, illuminator 31 is set to be turned off immediately after the execution instruction is provided. When an illuminance around building 80 is lower than the predetermined value (in other words, it is dark outside building 80) at the timing for providing an execution instruction, illuminator 31 is set to be turned off when a predetermined time elapses after the execution instruction is provided. The set control timing is stored as, for example, part of control information in storage 25. The predetermined value and the length of the predetermined time can be optionally set by the user.

Touch panel 21 then receives, from the user, the execution instruction to execute scene control (S43). Controller 24 acquires an environment sensing result from environment sensor 40 and determines whether the surrounding environment of building 80 satisfies predetermined requirements or not at the timing of the receiving of the execution instruction (S44). Specifically, controller 24 acquires a sensing result of an illuminance from environment sensor 40 and determines whether the surrounding environment of building 80 satisfies a requirement that an illuminance around building 80 is lower than the predetermined value at the timing of the receiving of the execution instruction. When it is determined that the surrounding environment of building 80 satisfies the predetermined requirements at the timing of the receiving of the execution instruction (Yes at S44), controller 24 causes the second device to include illuminator 31 that is set depending upon the environment (S45). When it is determined that the surrounding environment of building 80 does not satisfy the predetermined requirements at the timing of the receiving of the execution instruction (No at S44), controller 24 causes the first device to include illuminator 31 that is set depending upon the environment (S46).

Based on the control timing set in step S42, controller 24 executes the control of the first device immediately after the receiving of the execution instruction (S47). Based on the control timing set in step S42, controller 24 notifies the start of the control of the second device (S48) and then executes the control of the second device when a predetermined time period elapses after the receiving of the execution instruction (S49). When the second device is absent, step S48 and step S49 are omitted.

Hence, illuminator 31 is immediately turned off when the user provides an instruction to execute the scene control of “going-out” while it is bright outside building 80, whereas illuminator 31 is turned off later when the user provides an instruction to execute the scene control of “going-out” while it is dark outside building 80.

As described above, when the execution instruction is received in operation example 4, control system 10 executes the control of the first device and the control of the second device at different timings based on the surrounding environments of the first device and the second device at the time of the receiving of the execution instruction. According to operation example 4, control system 10 can adaptively change the control timing of illuminator 31 according to the surrounding environment at the timing of the instruction to execute scene control.

The surrounding environment is not limited to brightness (light environment). The surrounding environment includes a temperature environment, a humidity environment, and an air quality environment. For example, the control timing of air conditioner 32 may be determined according to at least one of a temperature environment outside building 80, a temperature environment in building 80, a humidity environment outside building 80, and a humidity environment in building 80.

### OPERATION EXAMPLE 5

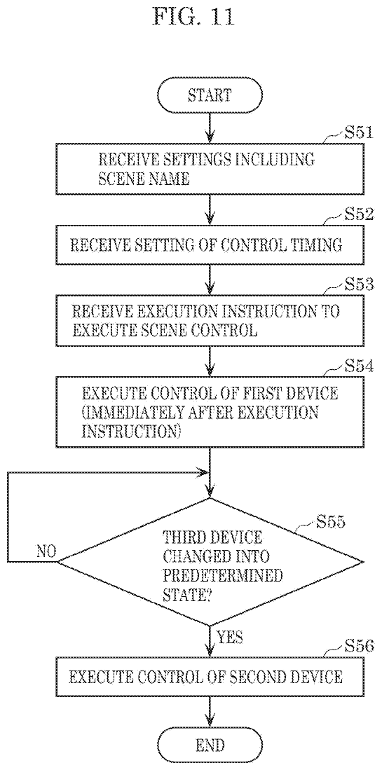

The setting of the control timing in operation example 1 may include the setting of different control timings according to a state of a device (hereinafter also referred to as a third device) other than devices to be controlled by scene control. FIG. 11 is a flowchart showing operation example 5 of control system 10. In the following description of operation example 5, differences from operation example 1 will be mainly discussed, and an explanation of matters mentioned above is optionally omitted or simplified.

Touch panel 21 of control device 20 first receives settings including a scene name, a device to be controlled, and the contents of control from the user (S51). Touch panel 21 of control device 20 then receives the setting of a control timing of scene control (S52).

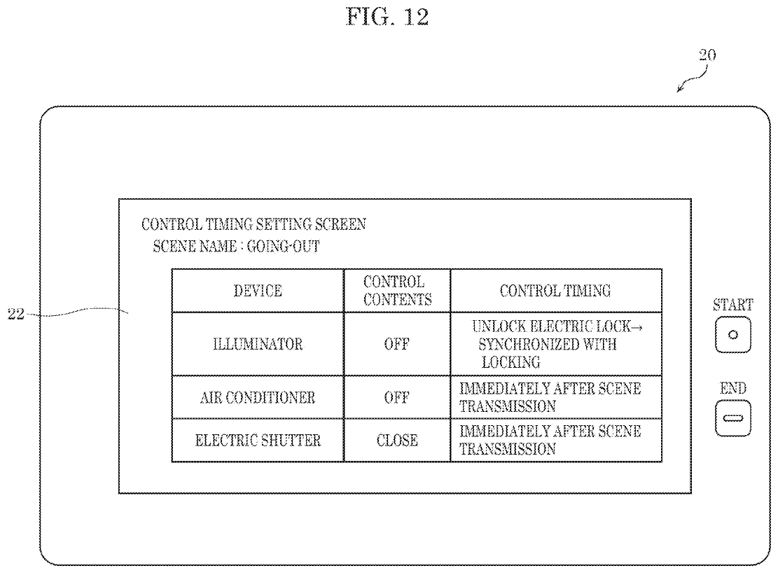

At this point, controller 24 displays a setting screen on display 22 as illustrated in FIG. 12. FIG. 12 is a diagram illustrating an example of the setting screen of control timings in operation example 5.

As illustrated in FIG. 12, operation example 5 controls three devices: illuminator 31, air conditioner 32, and electric shutter 34. In the setting screen, the control timing of illuminator 31 depends upon a state of electric lock 33 (an example of the third device) provided on an entrance door. Illuminator 31 is set to be turned off after the execution instruction is provided and when a state of electric lock 33 is changed from unlocking to locking. The set control timing is stored as, for example, part of control information in storage 25. The user can optionally set which one of devices 30 (third device) is to be linked to illuminator 31 (second device).

Thereafter, when touch panel 21 receives the execution instruction to execute scene control (S53), controller 24 executes, based on the control timing set in step S52, the control of the first device immediately after the receiving of the execution instruction (S54).

Controller 24 periodically acquires a state of the third device and determines whether the third device has changed into a predetermined state (S55). Specifically, controller 24 determines whether electric lock 33 has changed from an unlocked state to a locked state. The determination is continued until the third device changes into the predetermined state (No at S55). When it is determined that the third device has changed into the predetermined state (Yes at S55), controller 24 executes the control of the second device (S56). Specifically, controller 24 turns off illuminator 31.

Hence, illuminator 31 is turned off when the user provides an instruction to execute the scene control of “going-out” and goes out of building 80 to lock building 80 with electric lock 33.

As described above, when the execution instruction is received in operation example 5, control system 10 executes the control of the first device and the control of the second device at different timings based on a change of the state of the third device different from both of the first device and the second device. According to operation example 5, control system 10 can synchronize the control timing of illuminator 31 with the locking of electric lock 33. Operation example 5 may be combined with operation example 2.

### OPERATION EXAMPLE 6

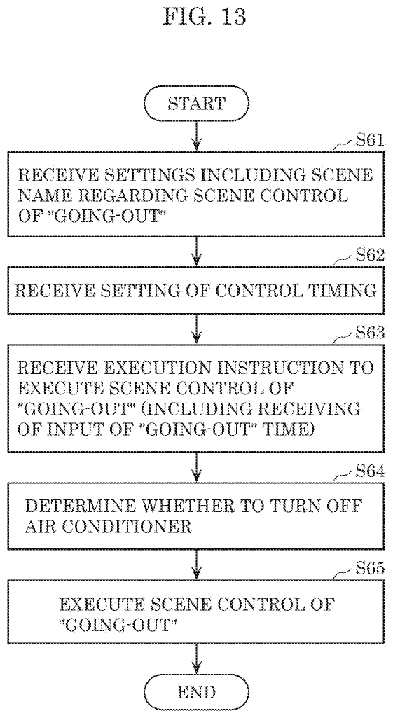

It is known that air conditioner 32 kept turned on can reduce power consumption during a short stay outside the building because of the performance improvement in recent years. This may interfere with the user's determination on whether to turn off air conditioner 32 when the user leaves the building. Thus, control system 10 may automatically determine whether to turn off air conditioner 32 when the execution instruction to execute the scene control of “going-out” is provided. FIG. 13 is a flowchart showing operation example 6 of control system 10. In the following description of operation example 6, differences from operation example 1 will be mainly discussed, and an explanation of matters mentioned above is optionally omitted or simplified.

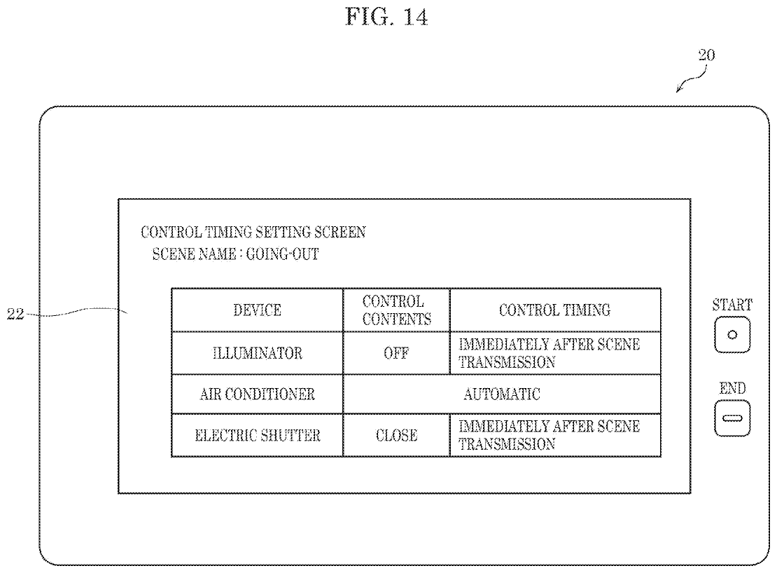

Touch panel 21 of control device 20 first receives, from the user, settings including a scene name, a device to be controlled, and the contents of control regarding the scene control of “going-out” (S61). Touch panel 21 of control device 20 then receives the setting of a control timing in the scene control of “going-out” (S62). At this point, controller 24 displays a setting screen on display 22 as illustrated in FIG. 14. FIG. 14 is a diagram illustrating an example of the setting screen of control timings in operation example 6.

As illustrated in FIG. 14, operation example 6 controls three devices: illuminator 31, air conditioner 32, and electric shutter 34. In the setting screen, the control contents and the control timing of air conditioner 32 are automatically (arbitrarily) set. In this case, controller 24 determines whether to turn off air conditioner 32 when the user provides the execution instruction to execute the scene control of “going-out.”

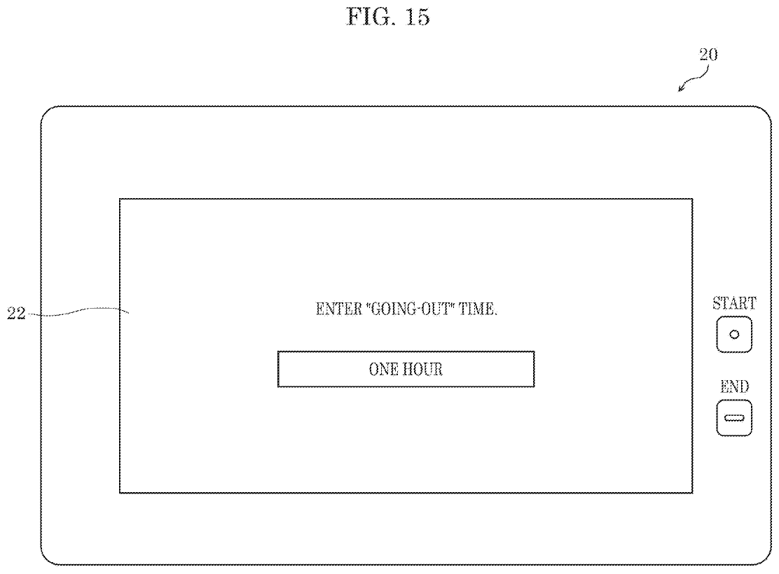

Touch panel 21 then receives, from the user, the execution instruction to execute the scene control of “going-out” (S63). In operation example 6, a user operation for an execution instruction to execute scene control includes an input of “going-out” time. For example, after the selecting operation of scene control of “going-out” by the user is received through touch panel 21, controller 24 displays the input screen of “going-out” time on display 22 before executing the scene control of “going-out.” FIG. 15 is a diagram illustrating an example of the input screen of “going-out” time.

The “going-out” time means a time from the exit of the user from building 80 to the return of the user to building 80. When touch panel 21 receives the input operation of time to spend out of home by the user, controller 24 determines whether to turn off air conditioner 32 based on the input “going-out” time (S64). For example, when the input “going-out” time is equal to or longer than a predetermined time, controller 24 determines that air conditioner 32 is to be turned off, whereas when the input “going-out” time is shorter than the predetermined time, controller 24 determines that air conditioner 32 is not to be turned off (the current operation is to be maintained).

Whether to turn off air conditioner 32 may be generally determined by further using at least one of a temperature in building 80, a temperature outside building 80, the settings (including a set temperature, an operation mode, and an air quantity) of air conditioner 32, history information about power consumption, and electricity charge information in addition to the “going-out” time.

For example, whether to turn off air conditioner 32 may be determined by using a machine learning model constructed in advance. For example, the machine learning model uses, as input information, at least one of a temperature in building 80, a temperature outside building 80, the settings (including a set temperature, an operation mode, and an air quantity) of air conditioner 32, history information about power consumption, electricity charge information, and the “going-out” time of the user. The machine learning model outputs information indicating whether to turn off air conditioner 32 based on the viewpoint (value) of the minimization of power consumption (or electricity charge). When the machine learning model is used, the “going-out” time needs not be input in step S62. For example, instead of using the “going-out” time, the “going-out” time may be estimated by using, as input information, a time when the execution instruction to execute the scene control of “going-out” is provided. In short, the “going-out” time may be indirectly specified.

Controller 24 executes the scene control of “going-out” (S65). In the scene control of “going-out,” air conditioner 32 is controlled according to the determination of step S64. Devices other than air conditioner 32 are controlled according to the settings of step S61 and step S62.

As described above, in operation example 6, when the execution instruction of scene control associated with the “going-out” scene is received, control system 10 determines whether to turn off air conditioner 32 based on a time length for which the user is out of the building. According to operation example 6, control system 10 can automatically determine whether to turn off air conditioner 32 when the user exits the building.

### Modification

In the foregoing embodiment, control system 10 executes the control of the first device immediately after the receiving of the execution instruction to execute scene control, and executes the control of the second device when a predetermined time period elapses after the receiving of the execution instruction. However, in control system 10, at least two of the devices need to have different control timings in scene control. For example, control system 10 may start controlling three or more devices at different timings in scene control. In scene control, device control needs not be started immediately after the receiving of the execution instruction to execute scene control. In other words, in scene control, the control of all devices may be started when a predetermined time elapses after the receiving of the execution instruction to execute scene control.

In the foregoing embodiment, the execution instruction to execute scene control is provided by manual input (operation input) to touch panel 21. The instruction may be provided as voice input to microphone 23.

The processing executed by control device 20 in the foregoing embodiment may be partially or entirely executed by server 50. For example, control device 20 may mainly act as a user interface while substantial information processing for scene control may be conducted by server 50.

### [Effects]

Control system 10 includes: input receiver 29 that receives an execution instruction to execute scene control associated with a life scene, the scene control including first control of controlling a first device and second control of controlling a second device; and controller 24 that executes the first control and the second control at different timings when the execution instruction is received.

Control system 10 configured thus executes the control of the first device (first control) and the control of the second device (second control) at different timings in scene control, thereby implementing flexible device control.

Furthermore, in operation example 1, controller 24: executes the first control immediately after the receiving of the execution instruction; and executes the second control when a predetermined time period elapses after the receiving of the execution instruction.

Control system 10 configured thus delays the control of the second device (second control) from the control of the first device (first control), thereby implementing flexible device control.

Furthermore, in operation example 1, controller 24 notifies start of the execution of the second control before executing the second control.

Control system 10 can notify the start of the execution of the control of the second device (second control) before executing the second control.

Furthermore, in operation example 1, input receiver 29 further receives, before the receiving of the execution instruction, a setting for at least one of a timing for executing the first control or a timing for executing the second control, and controller 24 executes the first control and the second control at different timings based on the setting, when the execution instruction is received.

Control system 10 configured thus receives the setting of the timing for executing device control from the user, thereby implementing flexible device control as desired by the user.

Furthermore, in operation example 2, input receiver 29 further receives a setting for at least one of a timing for executing the first control or a timing for executing the second control in addition to the execution instruction, and controller 24 executes the first control and the second control at different timings based on the setting, when the execution instruction is received.

Control system 10 configured thus receives the setting of the timing for executing device control immediately before executing scene control, allowing the user to provide an instruction of the timing for executing the control in consideration of the current circumstances. In other words, control system 10 can implement flexible device control.

Furthermore, in operation example 3, controller 24 executes the first control and the second control at different timings based on a time range in which the execution instruction is received, when the execution instruction is received.

Control system 10 configured thus can adaptively change the control timing of the first device or the second device according to a time range in which the execution instruction to execute scene control is provided. In other words, control system 10 can implement flexible device control.

Furthermore, in operation example 4, controller 24 executes the first control and the second control at different timings based on surrounding environment of the first device and the second device at a time of the receiving of the execution instruction, when the execution instruction is received.

Control system 10 configured thus can adaptively change the control timing of the first device or the second device according to a surrounding environment when the execution instruction to execute scene control is provided. In other words, control system 10 can implement flexible device control.

Furthermore, in operation example 5, controller 24 executes the first control and the second control at different timings based on a change of a state of a third device when the execution instruction is received, the third device being different from the first device and the second device.

Control system 10 configured thus can synchronize the control timing of illuminator 31 with the locking of electric lock 33. In other words, control system 10 can implement flexible device control.

Furthermore, in operation example 6, controller 24 further determines whether or not to turn off an air conditioner in a building based on a time length for which a user is out of the building, when the execution instruction to execute scene control related to a going-out scene is received.

Control system 10 configured thus can determine whether to turn off air conditioner 32 based on a time length for which a user is out of the building. In other words, control system 10 can implement flexible device control.

Furthermore, a control method executed by a computer such as control system 10, the control method includes: receiving an execution instruction to execute scene control associated with a life scene, the scene control including first control of controlling a first device and second control of controlling a second device; and executing the first control and the second control at different timings when the execution instruction is received in the receiving.

Control system 10 configured thus executes the control of the first device (first control) and the control of the second device (second control) at different timings in scene control, thereby implementing flexible device control.

### Other Embodiments

While the embodiment has been described above, the present invention is not limited to the foregoing embodiment.

For example, the foregoing embodiment specifically described a change of the control timing in the scene control of “going-out.” The present invention is also applicable to a change of a control timing in scene control other than “going-out.”

Moreover, the control system implemented by multiple devices in the foregoing embodiment may be implemented as a single device. For example, the control system may be implemented as a single device corresponding to a control device or may be implemented as a single device corresponding to a server for conducting the same processing as the control device. When the control system is implemented by multiple devices, constituent elements provided for the control system may be freely allocated to the devices.

For example, a communication method between devices in the foregoing embodiment is not particularly limited. The devices may communicate with one another via a relay, which is not illustrated.

It is possible in the above-described embodiments that the process performed by a certain processing unit may be performed by another processing unit, that an order of a plurality of processes is changed, or that a plurality of processes are performed in parallel. Any combinations of the above-described operation examples 1 to 6 and variations are also embodiments of the present invention.

In the above-described embodiments, each of the constituent elements may be implemented by executing a software program suitable for the constituent element. Each of the constituent elements may be implemented when a program executing unit, such a central processing unit (CPU) or a processor, reads a software program from a recording medium, such as a hard disk or a semiconductor memory, and executes the readout software program.

Each of the constituent elements may be implemented by a hardware. For example, the constituent elements may be circuits (or integrated circuit). The circuits may form a single circuit as a whole, or may be different circuits. Each of the circuits may be a general purpose circuit or a dedicated circuit.

The general and specific aspects according to present invention may be implemented to a system, a device, a method, an integrated circuit, a computer program, or a computer-readable recording medium such as a Compact Disc-Read Only Memory (CD-ROM), or may be any combination of them.

For example, the present invention may be implemented to a control method executed by a computer such as a control system, implemented to a program causing the computer to execute the control method, or implemented to a non-transitory computer-readable recording medium storing the program.

The present invention may include embodiments obtained by making various modifications on the above embodiments which those skilled in the art will arrive at, or embodiments obtained by selectively combining the elements and functions disclosed in the above embodiments, without materially departing from the scope of the present invention.

### REFERENCE SIGNS LIST

10 control system

24 controller

29 input receiver

30 device

32 air conditioner

1. A control system comprising:
an input receiver that receives an execution instruction to execute scene control associated with a life scene, the scene control including first control of controlling a first device and second control of controlling a second device; and
a controller that executes the first control and the second control at different timings when the execution instruction is received.

2. The control system according to claim 1, wherein
the controller:
executes the first control immediately after the receiving of the execution instruction; and
executes the second control when a predetermined time period elapses after the receiving of the execution instruction.

3. The control system according to claim 2, wherein
the controller notifies start of the execution of the second control before executing the second control.

4. The control system according to claim 1, wherein
the input receiver further receives, before the receiving of the execution instruction, a setting for at least one of a timing for executing the first control or a timing for executing the second control, and
the controller executes the first control and the second control at different timings based on the setting, when the execution instruction is received.

5. The control system according to claim 1, wherein
the input receiver further receives a setting for at least one of a timing for executing the first control or a timing for executing the second control in addition to the execution instruction, and
the controller executes the first control and the second control at different timings based on the setting, when the execution instruction is received.

6. The control system according to claim 1, wherein
the controller executes the first control and the second control at different timings based on a time range in which the execution instruction is received, when the execution instruction is received.

7. The control system according to claim 1, wherein
the controller executes the first control and the second control at different timings based on surrounding environment of the first device and the second device at a time of the receiving of the execution instruction, when the execution instruction is received.

8. The control system according to claim 1, wherein
the controller executes the first control and the second control at different timings based on a change of a state of a third device when the execution instruction is received, the third device being different from the first device and the second device.

9. The control system according to claim 1, wherein
the controller further determines whether or not to turn off an air conditioner in a building based on a time length for which a user is out of the building, when the execution instruction to execute scene control related to a going-out scene is received.

10. A control method executed by a computer, the control method comprising:
receiving an execution instruction to execute scene control associated with a life scene, the scene control including first control of controlling a first device and second control of controlling a second device; and
executing the first control and the second control at different timings when the execution instruction is received in the receiving.

11. A non-transitory computer-readable recording medium for use in a computer, the recording medium having a computer program recorded thereon for causing the computer to execute the control method according to claim 10.
